(19) United States
(12) Patent Application Publication
(10) Pub. No.: US 2017/0034772 A1
(43) Pub. Date: Feb. 2, 2017

(54) EXTENDING RANGE OF WIRELESS LOCAL NETWORKS

(71) Applicant: GainSpan Corporation, San Jose, CA (US)

(72) Inventor: Sibasis Purohit, Bangalore (IN)

(73) Assignee: GainSpan Corporation, San Jose, CA (US)

(21) Appl. No.: 14/930,667

(22) Filed: Nov. 3, 2015

(30) Foreign Application Priority Data
Jul. 29, 2015 (IN) 3892/CHE/2015

(51) Int. Cl. H04W 48/16; H04L 29/08

(52) U.S. Cl. CPC H04W 48/16; H04L 69/325; H04W 84/12

(57) ABSTRACT

A wireless device provided according to an aspect of the present disclosure extends the range of a wireless local network. In an embodiment, the wireless device receives a scan request from a new node to join the wireless local network, while the wireless device is operating as an end device of the wireless local network according to a network protocol. The wireless device communicates with the new node to join the new node to the wireless local network. The wireless device thereafter starts operating as a switch of the wireless local network according to the network protocol. The wireless device may further broadcast packets according to the network protocol to indicate availability of the switch to accept joining of additional end devices, after starting to operate as a switch.

### PRIORITY CLAIM

The instant patent application is related to and claims priority from the co-pending India provisional patent application entitled, “AUTOMATIC MODE CONFIGURATION BASED ON THE NETWORK TOPOLOGY DEMAND”, Serial No.: 3892/CHE/2015, Filed: 29 Jul. 2015, which is incorporated in its entirety herewith to the extent not inconsistent with the disclosure herein.

### BACKGROUND

Technical Field

Embodiments of the present disclosure relate generally to wireless local networks, and more specifically to extending range of wireless local networks.

Related Art

A wireless local network generally refers to a network in which end devices communicate with each other in a short distance (typically of the order of tens of meters) using wireless medium. Switches are commonly provided in wireless local networks to provide connectivity between end devices. A switch operates to receive a wireless packet from one end device and forward the received wireless packet to another (target) end device or to a switch which is in the path to the target end device.

Wireless local networks can be implemented in conformity with IEEE 802.11 family of standards, in which case the network is referred to as a WLAN (wireless local area network), the switch as an access point (AP) and end device as a wireless station, as is well known in the relevant arts. Wireless local networks can also be implemented to provide switching at the level of Internet Protocol (IP), in which case the networks, switches and end devices are respectively referred to as IP networks, routers and hosts, as is also well known in the relevant arts.

The range of a wireless local network may be viewed as a geographical area within which a new end device may join the wireless local network. The range of a wireless local network is often limited by factors such as transmission strength of the switches or end devices, any impediments in the line of transmission paths between switches and end devices, etc.

Aspects of the present disclosure are directed to extending the range of the wireless local networks so as to enable new end devices that were previously unable to join the wireless local networks, to be able to join the wireless local networks.

### BRIEF DESCRIPTION OF THE VIEWS OF DRAWINGS

Example embodiments of the present invention will be described with reference to the accompanying drawings briefly described below.

FIG. 1 is a block diagram of an example environment in which several aspects of the present disclosure may be implemented.

FIG. 2 is a flow chart illustrating the manner in which the range of a wireless local network is extended, in an embodiment of the present disclosure.

FIG. 3 is a block diagram depicting the movement of a host into a mesh network, in an embodiment of the present disclosure.

FIG. 4 is a timing diagram illustrating the manner in which a wireless device facilitates joining of a new node to the mesh network, in an embodiment of the present disclosure.

FIG. 5A is a block diagram of an example alternative environment in which several aspects of the present disclosure may be implemented.

FIG. 5B is a block diagram depicting the movement of a wireless station into a WLAN network, in an embodiment of the present disclosure.

FIG. 6 a timing diagram illustrating the manner in which a wireless station operates as an access point to enable a new node to join the WLAN, in an embodiment

FIG. 7 is a block diagram illustrating the implementation details of a wireless device in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A wireless device provided according to an aspect of the present disclosure extends the range of a wireless local network. In an embodiment, the wireless device receives a scan request from a new node to join the wireless local network, while the wireless device is operating as an end device of the wireless local network according to a network protocol. The wireless device communicates with the new node to join the new node to the wireless local network. The wireless device thereafter starts operating as a switch of the wireless local network according to the network protocol. As a result, the range of the wireless local network is extended without requiring manual intervention by any administrators of the wireless device or wireless local network.

The wireless device may further broadcast packets according to the network protocol to indicate availability of the switch to facilitate joining of additional end devices to the wireless local network, after starting to operate as a switch. As a result, the broadcast packets are avoided when the wireless device is not used for extending the range of wireless local network, thereby reducing the processing overhead for other devices in the wireless local networks.

In one embodiment, the wireless local network corresponds to a mesh network based on Internet Protocol (IP), where the end device is a host in the mesh network and the switch operates as an IP router after joining the new node to the wireless local network.

In another embodiment, the wireless local network corresponds to a WLAN (wireless local area network) based on IEEE 802.11 standards where the end device is a wireless station in the WLAN and the switch operates as an access point (AP) after joining the new node as a corresponding wireless station to the WLAN.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

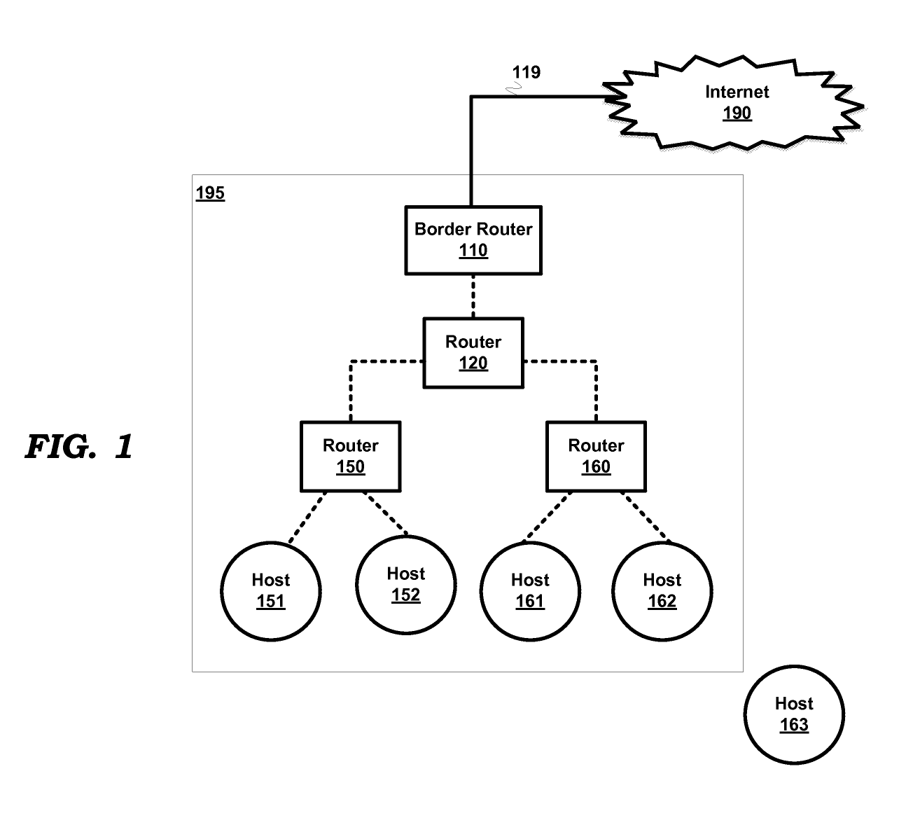

FIG. 1 is a block diagram representing an example environment in which several aspects of the present disclosure can be implemented. The example environment is shown containing only representative systems for illustration. However, real world environments may contain more or fewer systems. FIG. 1 is shown containing wireless devices 110, 120, 150, 151, 152, 160, 161, 162, 163, and Internet 190.

Wireless devices (generally referred to as “nodes”) 110, 120, 150, 151, 152, 160, 161, and 162 are shown part of wireless local network 195. Of these wireless devices, nodes 151, 152, 161, and 162 operate as end devices, and nodes 110, 120, 150, and 160 operate to provide the functions of the switch noted above.

The hierarchy of nodes in wireless local network 195 is formed according to protocols such as Routing Protocol for Low Power and Lossy Networks (RPL). RPL is an IP-based routing protocol, which is described in further detail in RFC 6550 entitled, “RPL protocol (IPv6 Routing Protocol for Low-Power and Lossy Networks)”, by the Internet Engineering Task Force (IETF). RPL imposes a hierarchical structure with one of the switches as the border router, one or more other switches as routers, and end devices as hosts. Upon one of the switches becoming unavailable, the RPL protocol re-defines the hierarchy based on the connectivity available among other available switches.

Wireless local network 195 is implemented as a mesh network (hereinafter referred to as “mesh 195”). As is well known in the relevant arts, in a mesh network, each node relays data for the network and all nodes cooperate in the distribution of data in the network. Accordingly, the embodiment of FIG. 1 is shown operating to create a hierarchy (by operation of RPL), with border router 110 representing the root of the hierarchy, and end devices representing corresponding leaf nodes of the hierarchy. Each dotted line of FIG. 1 represents a direct wireless path between two adjacent nodes in the formed hierarchy.

Consistent with the terminology in IP networks, the end devices are shown referred to as hosts and the switch-equivalent devices (in terms of functions noted in the background section) are shown referred to as routers. The corresponding pairs of nodes (routers/hosts, connected by a dotted line) are within the communication range of each other, implying that each of hosts can send a layer-2 packet which is directly (i.e., no intermediate forwarders, etc.) received by the corresponding router and vice versa. Further, host 163 is shown outside mesh 195, representing a host attempting to join mesh 195.

Internet 190 extends the connectivity of nodes in mesh 195 to various systems (not shown) connected to, or part of, Internet 190. Internet 190 is shown connected to border router 110 through a wired path 119. Internet 190 may be implemented using protocols such as IP. In general, in IP environments, an IP packet is used as a basic unit of transport, with the source address being set to the IP address assigned to the source system from which the packet originates and the destination address set to the IP address of the destination system to which the packet is to be eventually delivered. The IP packet is encapsulated in the payload of layer-2 packets when being transported across mesh networks.

An IP packet is said to be directed to a destination system when the destination IP address of the packet is set to the IP address of the destination system, such that the packet is eventually delivered to the destination system. When the packet contains content such as port numbers, which specifies the destination application, the packet may be said to be directed to such application as well. The destination system may be required to keep the corresponding port numbers available/open, and process the packets with the corresponding destination ports.

Although shown as “hosts” in FIG. 1, in general, a host may additionally operate as a router and revert to operating just as a host, as will be described in more detail below.

Data exchange between nodes in mesh 195 can occur according to the IP protocol, well known in the relevant arts. Each of the routers of mesh 195 would contain routing tables with entries specifying a next-hop node to which a received packet is to be forwarded for eventual delivery to a destination node. Hosts on the other hand may also have routing tables, which contain information (such as address) specifying a parent router node to which a received packet is to be forwarded for eventual delivery to a destination node.

Border router 110, as well as each of the router nodes 120, 150, and 160 of FIG. 1, store routing information (e.g., in the form of routing tables) to enable routing of unicast packets by forwarding the unicast packets to a corresponding next-hop node in mesh 195, as is well known in the relevant arts. In the case of a broadcast, all nodes in mesh 195 receive a broadcast packet, where the broadcast packet is further processed.

Each of hosts 151, 152, 161, and 162 implement a user function. For example, each of the hosts may contain one or more sensors to obtain measurements/values of physical quantities such as temperature, pressure etc. Applications that are executed on the hosts may respectively process the corresponding data received from the sensors to implement a corresponding user function such as data collection.

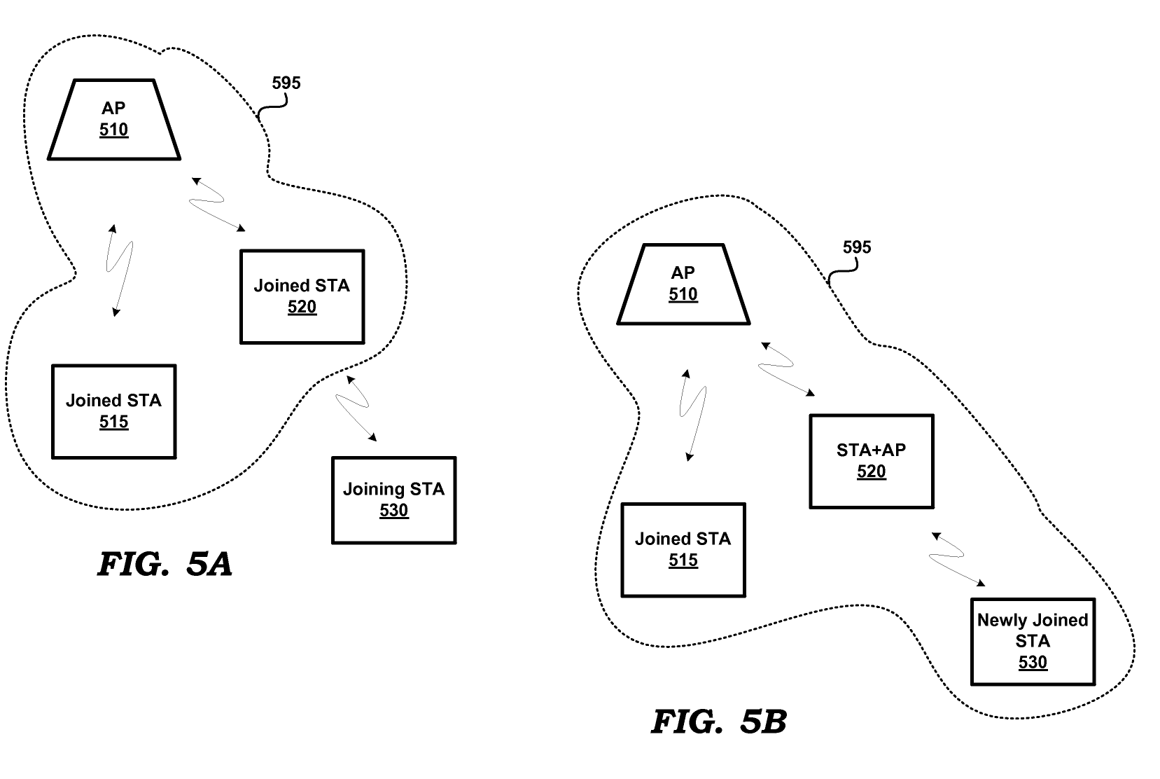

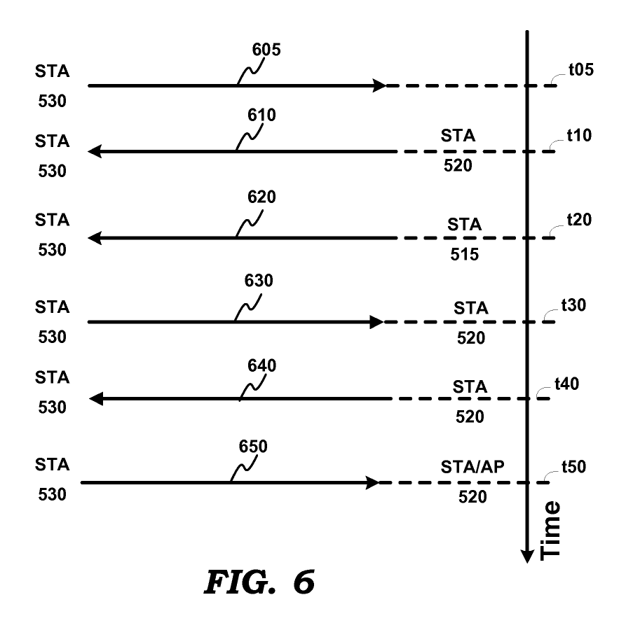

Though the nodes in FIG. 1 are described as being formed according to RPL protocols (forming a mesh 195), in alternative embodiments, however, the wireless local network may be formed using other approaches (e.g., as described in FIGS. 5A-5B, and FIG. 6). In general a neighbor relationship may exist between any number of nodes with other nodes, though the specific embodiment of FIG. 1 shows the nodes in a hierarchical relationship.

In real world scenarios, new nodes such as host 163 may attempt to join mesh 195. In situations where joining mesh 195 is outside of the range of mesh 195, e.g., due to the transmission range of the nearest router 160 not extending as far as where end device 163 is geographically located, host 163 may be unable to join mesh 195. Such hosts outside of range of the wireless local networks may be referred to as orphan nodes (as not having a switch/AP/router, facilitating joining of the wireless local network).

At least to permit such orphan nodes to join the network, it would be advantageous to extend the range of the network. Aspects of the present disclosure relate to extending the range of the network, as described below with examples.

### 3. Extending Range of a Wireless Local Network

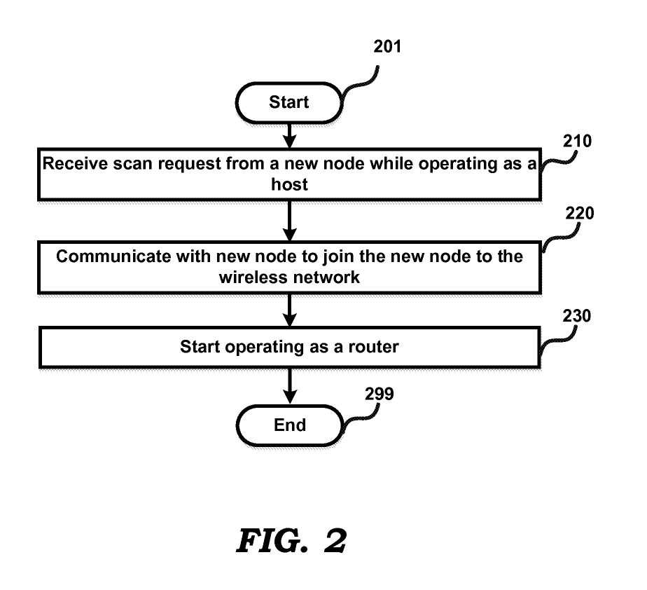

FIG. 2 is a flow chart illustrating the manner in which the range of a wireless local network is extended, in an embodiment of the present disclosure. Merely for illustration, the flowchart is described below as being performed in host 162 in mesh 195. However, the features can be implemented in any other host (e.g., hosts 151, 152, 161) also, as well as in other environments (e.g., the WLAN described in FIGS. 5A-5B, and FIG. 6), without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, host 162 receives a scan request from a new node while host 162 is operating as a host. As is well known in the relevant arts, a scan request is transmitted by a new host expressing interest to join a wireless local network. Operation as a host implies that the host 162 is either a source or a destination of IP packets in the wireless local network, contrasted with the switching function provided by routers in mesh networks. When host 162 is a source, the IP packet transmitted to a router (parent) would contain data originating at host. On the other hand, when host 162 is a destination, the data in the payload of the packet received from the parent is delivered to a local application.

In step 220, wireless device 162 communicates with the new node to join the new node to the wireless network. The content of packets exchanged for completing the joining of the new node to the wireless network depends on the network protocol in the wireless network. However, host 162 is joined to mesh network 195 due to the communication.

In step 230, upon joining the new node to the wireless network, wireless device 162 starts operating as a router (also termed generally as a switch). Operating as a router refers to the ability of the host to perform a switching function, e.g., to accept data packets from the new node and send them to the nearest AP/router, e.g., router 160. Further, operating as a router refers to the ability of the host to send periodic packets to indicate availability of the host to accept join requests from other new nodes. As the operation as a router starts upon the joining of the new node, such change to router mode does not require the manual intervention of a user/(network) administrator of the wireless network or of the wireless device.

Therefore, host 163 becomes part of mesh 195, and subsequent data exchanges between host/router 162 and host 163 may occur uninterruptedly so long as they are within communication range of each other. The flowchart ends in step 299.

If wireless device 162 or the other hosts 151, 152, and 161 operated as routers prior to receiving a join request from the new node, there would be potential wastage of power and/or reduction in the bandwidth of the mesh network. For example, regardless of whether or not a new node is joined, hosts operating as routers periodically send packets related to routing information, which unnecessarily clutter the wireless network. This would also result in wastage of power in the host nodes, which may be power-sensitive due to their often portable nature (e.g., when implemented as battery-powered remote sensors in a network, without a dedicated power supply). The hosts, therefore, can save on power as well as conserve network bandwidth by starting to operate as a router only when prompted by a new node to do so (via a join request).

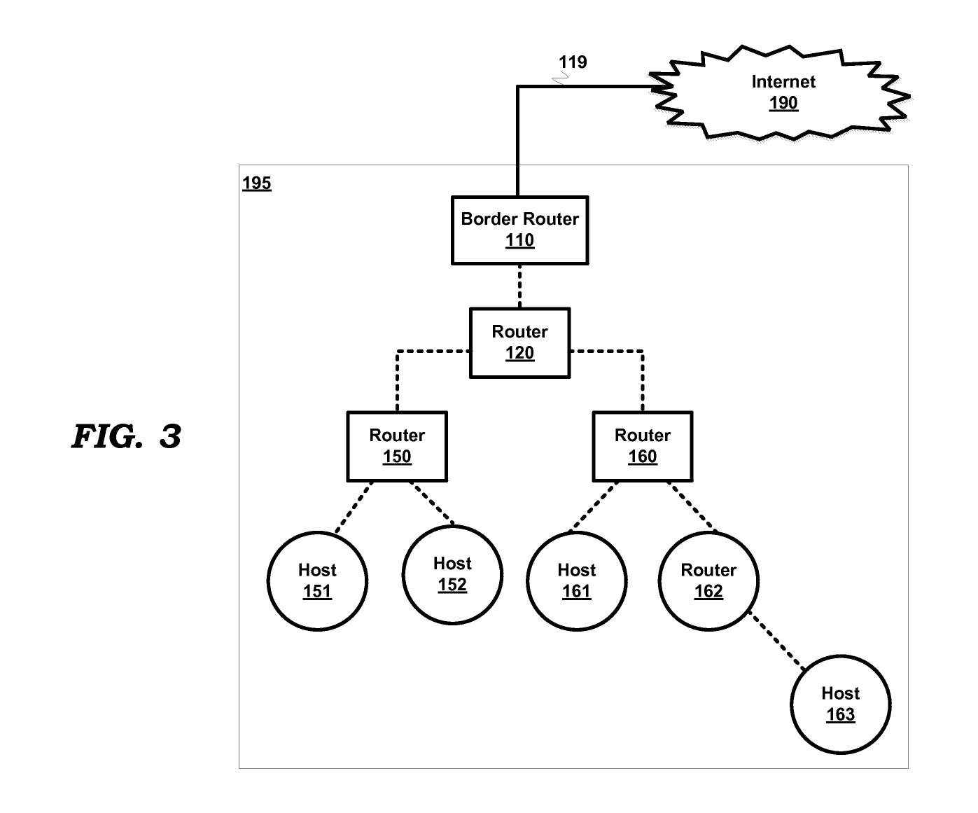

In an embodiment (as described below with reference to FIG. 3), the sending/receiving of the packets to/from the new node occurs without any association/authentication having to occur between the host and the new node, unlike the traditional AP/wireless station setup, where a wireless station exchanges association/authentication information with the corresponding AP prior to sending/receiving packets to/from the AP.

Accordingly, the range of mesh 195 is extended due to the operation of node 162. The remaining hosts 151, 152, 161 and 163 may be similarly designed to further extend the range of mesh 195. The description is continued with respect to a block diagram depicting the movement of host 163 into the mesh network 195.

### 4. New Node Joining the Wireless Local Network

FIG. 3 is a block diagram depicting the state of mesh 195 after new node 163 completes joining mesh network 195. Each component of FIG. 3 with a similar name (e.g., border router, router, host, etc.) performs similar function as the corresponding component in FIG. 1, and the description is not repeated for conciseness.

In an embodiment of the present disclosure, each of the hosts 151, 152, 161, and 162 is capable of operating as a router or as a host. Accordingly, operation as a router as well as a host can be performed while operating in a single channel (single transmit/receive radio, each tuned to transmit/receive on a same/single frequency band).

As such, the operation as a router and as a host implies that processing capabilities for operation as a router as well as to operate as a host are active/available simultaneously/concurrently, and the corresponding set of processing capabilities can be invoked on the basis of the requirements of the node. For example, the node may operate as a router by inspecting a proprietary field of a received packet, e.g., network ID of wireless mesh network 195, whereas the node may operate as a host by processing incoming measurements of physical values such as temperature, pressure etc. Such dual-mode of operation (i.e., as a router and as a host) may be based on time division multiplexing (TDM), implying that the node operates in router mode and host mode in alternate non-overlapping durations, as is well known in the relevant arts.

As shown, it is assumed that host 163 (while being a new node) has requested to join the mesh 195, and wireless device 162, previously operating as a host only, starts operating as a router, so that host 163 could join the mesh network 195. Therefore, host 163 is shown as part of mesh 195 in FIG. 3.

In an embodiment, each of the hosts 151, 152, 161 and 162 in mesh 195 is designed with the capability to operate as a conventional router/host (the operations of which are well known in the relevant arts, and are not described herein), as well as to operate in an un-associated data transfer mode.

“Un-associated data transfer mode” refers to an operating mode of a node (router or host), in which data transfer occurs between a host and a router (or a wireless station and an AP) without requiring association and authentication procedures. When operating as a host in the un-associated data transfer mode, the host does not transmit association and authentication frames to the router, but sends/receives packets to/from the router without such association/authentication having to occur. Similarly, operating as a router in un-associated data transfer mode does not require the corresponding host node to be associated with it, for operating as a switch in forwarding the packets from/to the host. Therefore, if the router and the hosts of mesh 195 are implemented to operate in unassociated data transfer mode, host 163 joins mesh 195 in un-associated data transfer mode.

The features noted described above can be implemented in various ways in different embodiments. The description is continued with respect to a timing diagram illustrating the manner in which wireless device 162 facilitates joining of new node 163 to mesh network 195, in an embodiment of the present disclosure.

### 5. Timing Diagram Representing New Node Joining a Mesh Network

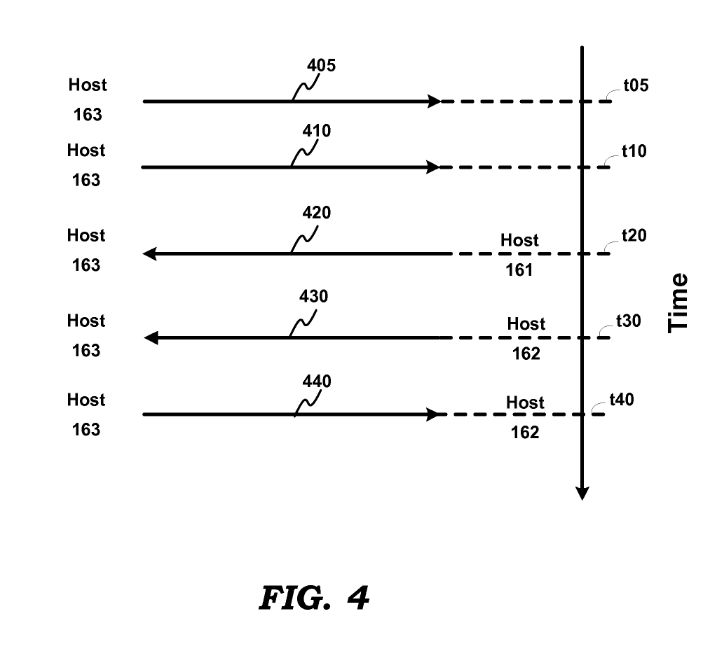

FIG. 4 is a timing diagram illustrating the manner in which a host starts operating as a router to enable an new host to join the wireless local network (specifically, a mesh network), in an embodiment, as described above with respect to flowchart of FIG. 2.

The operation of the timing diagram is described with respect to Destination-Oriented Directed Acyclic Graph (DODAG) Information Object (DIO) messages, DODAG Information Solicitation (DIS) messages, and Destination Advertisement Object (DAO) messages, which are described according to the RPL protocol, as is well known in the relevant arts. As noted above, RPL is an IP-based routing protocol, which is described in further detail in RFC 6550 entitled, “RPL protocol (IPv6 Routing Protocol for Low-Power and Lossy Networks)”, by the Internet Engineering Task Force (IETF).

At time t05 and time t10, host 163 sends DIS/scan requests 405 and 410. As is well known in the relevant arts, a DIS request is a scan request (a broadcast message) that solicits DIO responses from other devices. Among other things, the DIO responses (coming from the devices which respond to the scan request) contain information on the type of device (e.g., in a “device type” field that indicates whether the responding device is a host or a router). Although only two scan requests are shown, it is assumed that host 163 sends multiple DIS scan requests (say at least Y DIS scan requests in duration of X seconds) in an attempt to find a router to join the network.

At time t20 and time t30, host 163 receives DIO responses 420 and 430 from hosts 161 and 162 respectively. Based on the information contained in the DIO responses 420 and 430, host 163 determines that the DIO responses to the scan requests are all from other hosts but not routers. Not receiving DIO probe responses from any routers (despite multiple scan requests, as noted above) indicates that no current routers are available to permit host 163 to join mesh network 195. Should a DIO probe request be received from any of the routers of mesh 195, the host 163 would be deemed to be within the range of mesh 195 and no extension of range is necessary.

Since host 163 is outside of range of mesh 195, at time t40, host 163 sends the DAO request 440 to host 162 (assuming host 162 is selected over host 161, for example, due to higher power with which transmissions from host 162 are received), with message 440 being a request to join a host in mesh 195 (i.e., a “join” request). Thereafter, new node 163 joins mesh network 195. And, host 163 and wireless device 162 are in communication range of each other such that all data sent from host 163 is now routed through wireless device 162 to other nodes of the mesh 195, including routers (e.g., 160) and other hosts (e.g., 161).

In the duration following time point t40, wireless device 162 operates as a router for purpose of host 163, while also operating as an independent host for the purpose of data originating from or destined to host (or end device) 162. Host 163, by virtue of operating as a router, can accept joining of additional new hosts also in a known way.

The description is continued with respect to a block diagram depicting the operation with respect to an alternative environment.

### 6. New Node Joining 802.11 Wireless Local Network

FIGS. 5A and 5B depicts the state of a wireless local network 595 before and after a new node 530 completes joining wireless local network 595. Wireless local network 595 is implemented as a WLAN (as described above), in conformity with IEEE 802.11 family of standards. Therefore, the switch is referred to as an access point (AP) and end device as a wireless station (STA). Further, the wireless devices of FIGS. 5A and 5B are assumed to be implemented in a Peer-to-Peer (P2P) model. As is well known in the relevant arts, P2P model is a decentralized communications model in which each party (i.e., wireless device) has the same capabilities and either party can initiate a communication session.

In an embodiment of the present disclosure, STAs 515 and 520 are capable of operating as an AP or as an STA. Accordingly, operation as an AP as well as an STA can be performed while operating in a single channel (single transmit/receive radio, each tuned to transmit/receive on a same/single frequency band).

Similar to the embodiments described above with reference to FIG. 3, the operation as an AP and as an STA implies that processing capabilities for operation as an AP as well as an STA are active/available simultaneously/concurrently, and the corresponding set of processing capabilities can be invoked on the basis of the requirements of the node.

As shown in FIG. 5A, it is assumed that STA 530 (while being a new node) has requested to join WLAN 595. The join request may be part of a management frame of a layer-2 packet. Various management frame formats are described in detail in IEEE Std 802.11™-2012 available from IEEE. Management frames typically contain some pre-defined fields (e.g., universal organization ID) as well as vendor-specific information element fields, which are fields that are customizable to suit a particular vendor's requirements.

In the example of FIGS. 5A and 5B, the join request is programmed into the vendor-specific information element fields. Specifically, information on the vendor of the new node (e.g., the name/identity of the manufacturer), the identity of the default AP to which the new node typically connects to join the mesh network, etc., are all populated in the vendor-specific information fields.

In FIG. 5B, it is shown that STA 520, previously operating as an STA only, starts operating as an AP, so that STA 530 could join WLAN 595. Therefore, STA 530 is shown as part of WLAN 595 in FIG. 5B.

The description is continued with respect to a timing diagram illustrating an example communication based on which STA 530 facilitates joining of a new node 520 to WLAN 595, in an embodiment of the present disclosure.

### 7. Timing Diagram in an 802.11 Network

FIG. 6 is a timing diagram illustrating the manner in which an STA operates as an AP to enable a new node to join the wireless local network, in an embodiment.

At time t05, STA 530 (i.e., the new node), which is in a discovery mode, sends a probe request message 605 in accordance with 802.11 standards, with message 605 being a broadcast request to scan for an AP in WLAN 595.

It is assumed that STA 530 sends multiple probe request messages (say at least Y probe request messages in duration of X seconds) in an attempt to find an AP to join the network. As is well known in the relevant arts, a probe request message solicits probe responses from other devices such as APs and STAs. Among other things, the probe responses (coming from the devices which respond to the probe request) contain information on the type of device (e.g., in a “device type” field that indicates whether the responding device is an AP or an STA).

At time t10, STA 520, which was in a listening mode, accepts the probe request and transmits a probe response message 610 to STA 530, with message 610 indicating availability of STA 520 to operate as an AP to enable STA 530 to operate as a part of WLAN 595. Similarly, at time t20, STA 515 transmits message 620 to STA 530, indicating availability. As noted above, both probe responses 610 and 520 contain information that identifies their respective STAs 520 and 515 as STAs and not as APs.

It is assumed that STA 530 selects STA 530 from the list of devices (e.g., STA 515, STA 520) from which it receives a probe response. Thereafter, a three-way handshake, namely a Group Owner (GO) negotiation phase ensues to complete the joining of STA 530 to WLAN 595.

First, at time t30, STA 530 sends a GO negotiation request frame to STA 520 with an intent to join STA 520 (i.e., a “join” request). At time t40, STA 520 responds with a GO negotiation response which confirms availability of STA 520 to begin operating as an AP. At time t50, STA 530 sends a GO negotiation confirmation message to STA 520 accepting STA 520 as the AP. Thereafter, STA 530 joins WLAN 595. And, STA/AP 530 and STA 520 are in communication range of each other such that all data sent from STA 530 is now routed through STA/AP 520 to other nodes of WLAN 595, including APs (e.g., 510) and other STAs (e.g., 515). In the duration following time point t50, STA 520 operates as an AP for purpose of STA 530, while also operating as an independent host for the purpose of data originating from or destined to STA 520.

The description is continued with respect to the internal details of a wireless device (node) in an embodiment.

### 8. Wireless Station

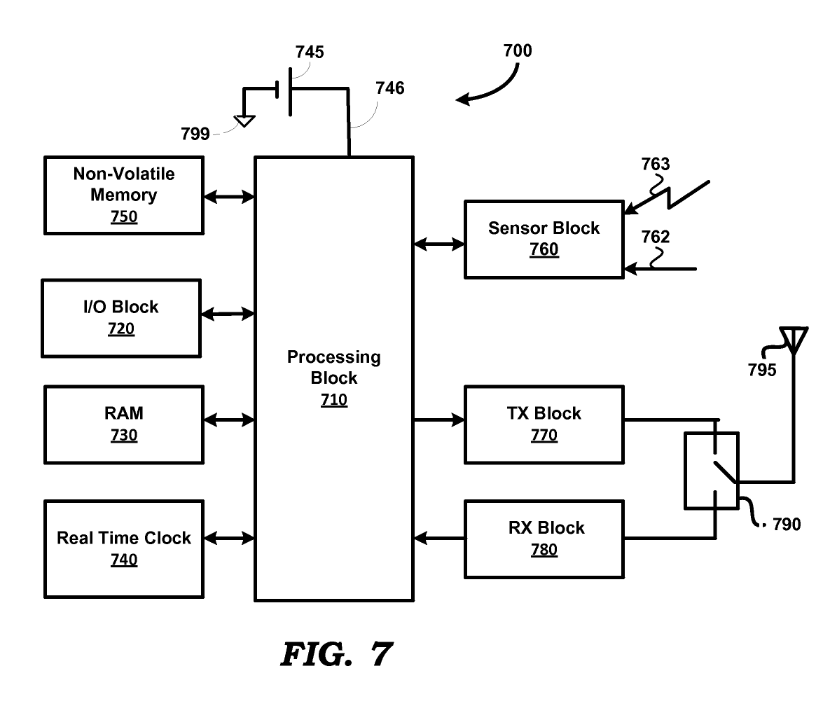

FIG. 7 is a block diagram showing the implementation details of a wireless device in an embodiment of the present disclosure. Wireless device 700 may correspond to host 162 of wireless mesh network 195 of FIG. 1 or STA 520 of WLAN 595 of FIGS. 5A and 5B. Wireless device 700 is shown containing processing block 710, input/output (I/O) block 720, random access memory (RAM) 730, real-time clock (RTC) 740, battery 745, non-volatile memory 750, sensor block 760, transmit (TX) block 770, receive (RX) block 780, switch 790, and antenna 795. The whole of wireless device 700 may be implemented as a system-on-chip (SoC), except for battery 745 and antenna 795. Alternatively, the blocks of FIG. 7 may be implemented on separate integrated circuits (IC). Terminal 799 represents a ground terminal.

Battery 745 provides power for operation of wireless device 700, and may be connected to the various blocks shown in FIG. 7. While wireless device 700 is shown as being battery-powered, in another embodiment, wireless device 700 is mains-powered and contains corresponding components such as transformers, regulators, power filters, etc. RTC 740 operates as a clock, and provides the ‘current’ time to processing block 710.

I/O block 720 provides interfaces for user interaction with wireless device 700. Sensor block 760 may contain one or more sensors, as well as corresponding signal conditioning circuitry, and provides to processing block 710, measurements/values of physical quantities such as temperature, pressure, etc., sensed via wired path 762 or wireless path 763. Sensor block 760 may perform analog-to-digital conversion of the measurement/values prior to forwarding the measurements/values to processing block 710. When wireless device 700 is implemented as a border router 110 (in FIG. 1), sensor block 760 may not be included.

Antenna 795 operates to receive from, and transmit to, a wireless medium, corresponding wireless signals (e.g., according to IEEE 802.11 (WLAN) standards). Switch 790 may be controlled by processing block 710 (connection not shown) to connect antenna 795 to one of blocks 770 and 780 as desired, depending on whether transmission or reception of wireless signals is required. Switch 790, antenna 795 and the corresponding connections of FIG. 7 are shown merely by way of illustration. Instead of a single antenna 795, separate antennas, one for transmission and another for reception of wireless signals, can also be used. Various other techniques, well known in the relevant arts, can also be used instead.

TX block 770 receives, from processing block 710, packets (such as the data packets that need to be transmitted to a parent router, as described above) to be transmitted on a wireless signal (e.g., according to a wireless standard such as IEEE 802.11), generates a modulated radio frequency (RF) signal (according to the standard), and transmits the RF signal via switch 790 and antenna 795. TX block 770 may contain RF and baseband circuitry for generating and transmitting wireless signals, as well as for medium access operations. Alternatively, TX block 770 may contain only the RF circuitry, with processing block 710 performing the baseband and medium access operations (in conjunction with the RF circuitry).

RX block 780 represents a receiver that receives a wireless (RF) signal (e.g., according to IEEE 802.11) bearing data and/or control information (e.g., the incoming management frames or join requests sent by new nodes) via switch 790, and antenna 795, demodulates the RF signal, and provides the extracted data or control information to processing block 710. RX block 780 may contain RF as well as baseband processing circuitry for processing a WLAN signal. Alternatively, RX block 780 may contain only the RF circuitry, with processing block 710 performing the baseband operations in conjunction with the RF circuitry.

Non-volatile memory 750 is a non-transitory machine readable medium, and stores instructions, which when executed by processing block 710, causes wireless device 700 to operate as a router and as a host. In particular, the instructions enable the wireless device 700 to operate respectively as a router and as a host as described with respect to the flowchart of FIG. 2.

RAM 730 is a volatile random access memory, and may be used for storing instructions and data. RAM 730 and non-volatile memory 750 (which may be implemented in the form of read-only memory/ROM/Flash) constitute computer program products or machine (or computer) readable medium, which are means for providing instructions to processing block 710. Processing block 710 may retrieve the instructions, and execute the instructions to provide several features of the present disclosure.

Processing block 710 (or processor in general) may contain multiple processing units internally, with each processing unit potentially being designed for a specific task. Alternatively, processing block 710 may contain only a single general-purpose processing unit. Processing block 710 may execute instructions stored in non-volatile memory 750 or RAM 730 to enable wireless device 700 to operate according to several aspects of the present disclosure (as corresponding to router or host), described above in detail.

### 7. Conclusion

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method performed in a wireless device of a wireless local network, said method comprising:
receiving a scan request from a new node to join said wireless local network, while said wireless device is operating as an end device of said wireless local network according to a network protocol;
communicating with said new node to join said new node to said wireless local network; and
start operating as a switch of said wireless local network according to said network protocol upon joining said new node to said wireless local network.

2. The method of claim 1, wherein after commencing operation as said switch, said wireless device further operates to broadcast packets according to said network protocol to indicate availability of said switch to facilitate joining of additional end devices to said wireless local network.

3. The method of claim 2, wherein said wireless device operates as said end device according to said network protocol also while operating as said switch after joining said new node to said wireless local network.

4. The method of claim 3, wherein said wireless local network is implemented as a mesh network based on Internet Protocol (IP) such that said network protocol is IP, wherein said end device is a host in said mesh network and said switch operates as an IP router after joining said new node to said wireless local network.

5. The method of claim 4, wherein said scan request is in the form of a DIS frame, wherein said communicating comprises:
sending a DIO frame as a response to said DIS frame, wherein said DIO frame contains a field indicating that said wireless device is operating only as a host, and not as a router; and
receiving a join request in the form of a DAO frame indicating that said new node is accepting said wireless device as said router for joining said mesh network, and
wherein said wireless device starts operating as said switch after receiving said DAO frame.

6. The method of claim 3, wherein said wireless local network is implemented as a WLAN (wireless local area network) based on IEEE 802.11 standards such that said network protocol is in accordance with IEEE 802.11 standards, wherein said end device is a wireless station in said WLAN and said switch operates as an access point (AP) after joining said new node as a corresponding wireless station to said WLAN.

7. The method of claim 6, wherein said scan request is in the form of a probe request in accordance with said IEEE 802.11 standards, wherein said communicating comprises:
sending a probe response as a response to said probe request, wherein said probe response contains a field indicating that said wireless device is operating only as a wireless station, and not as an AP;
receiving a join request in the form of a negotiation frame indicating that said new node is accepting said wireless device as said AP for joining said WLAN;
sending a negotiation response to said new node confirming acceptance to operate as said AP to join said new node as a wireless station; and
receiving a confirmation frame from said new node accepting said wireless device as said AP,
wherein said wireless device starts operating as said AP after receiving said confirmation frame.

8. A non-transitory machine readable medium storing one or more sequences of instructions for operating a wireless device of a wireless network, wherein execution of said one or more instructions by one or more processors contained in said wireless device enables said wireless device to perform the actions of:
receiving a scan request from a new node to join said wireless local network, while said wireless device is operating as an end device of said wireless local network according to a network protocol;
communicating with said new node to join said new node to said wireless local network; and
start operating as a switch of said wireless local network according to said network protocol upon joining said new node to said wireless local network.

9. The non-transitory machine readable medium of claim 8, wherein operating as said switch comprises broadcasting packets according to said network protocol to indicate availability of said switch to accept joining of additional end devices.

10. The non-transitory machine readable medium of claim 9, wherein said wireless device operates as said end device according to said network protocol also while operating as said switch after joining said new node to said wireless local network.

11. The non-transitory machine readable medium of claim 10, wherein said wireless local network is implemented as a mesh network based on Internet Protocol (IP) such that said network protocol is IP, wherein said end device is a host in said mesh network and said switch operates as an IP router after joining said new node to said wireless local network.

12. The non-transitory machine readable medium of claim 11, wherein said scan request is in the form of a DIS frame, wherein said communicating comprises:
sending a DIO frame as a response to said DIS frame, wherein said DIO frame contains a field indicating that said wireless device is operating only as a host, and not as a router; and
receiving a join request in the form of a DAO frame indicating that said new node is accepting said wireless device as said router for joining said mesh network, and
wherein said wireless device starts operating as said switch after receiving said DAO frame.

13. The non-transitory machine readable medium of claim 10, wherein said wireless local network is implemented as a WLAN (wireless local area network) based on IEEE 802.11 standards such that said network protocol is in accordance with IEEE 802.11 standards, wherein said end device is a wireless station in said WLAN and said switch operates as an access point (AP) after joining said new node as a corresponding wireless station to said WLAN.

14. The non-transitory machine readable medium of claim 13, wherein said scan request is in the form of a probe request in accordance with said IEEE 802.11 standards, wherein said communicating comprises:
sending a probe response as a response to said probe request, wherein said probe response contains a field indicating that said wireless device is operating only as a wireless station, and not as an AP;
receiving a join request in the form of a negotiation frame indicating that said new node is accepting said wireless device as said AP for joining said WLAN;
sending a negotiation response to said new node confirming acceptance to operate as said AP to join said new node as a wireless station; and
receiving a confirmation frame from said new node accepting said wireless device as said AP,
wherein said wireless device starts operating as said AP after receiving said confirmation frame.

15. A wireless device of a wireless network, said wireless device comprising:
a processing block and a memory,
said memory to store instructions which when retrieved and executed by said processing block causes said wireless device to perform the actions of:
receiving a scan request from a new node to join said wireless local network, while said wireless device is operating as an end device of said wireless local network according to a network protocol;
communicating with said new node to join said new node to said wireless local network; and
start operating as a switch of said wireless local network according to said network protocol upon joining said new node to said wireless local network.

16. The wireless device of claim 15, wherein said wireless device operates as said end device according to said network protocol also while operating as said switch after joining said new node to said wireless local network.

17. The wireless device of claim 16, wherein said wireless local network is implemented as a mesh network based on Internet Protocol (IP) such that said network protocol is IP, wherein said end device is a host in said mesh network and said switch operates as an IP router after joining said new node to said wireless local network.

18. The wireless device of claim 17, wherein said scan request is in the form of a DIS frame, wherein said communicating comprises:
sending a DIO frame as a response to said DIS frame, wherein said DIO frame contains a field indicating that said wireless device is operating only as a host, and not as a router; and
receiving a join request in the form of a DAO frame indicating that said new node is accepting said wireless device as said router for joining said mesh network, and
wherein said wireless device starts operating as said switch after receiving said DAO frame.

19. The wireless device of claim 16, wherein said wireless local network is implemented as a WLAN (wireless local area network) based on IEEE 802.11 standards such that said network protocol is in accordance with IEEE 802.11 standards, wherein said end device is a wireless station in said WLAN and said switch operates as an access point (AP) after joining said new node as a corresponding wireless station to said WLAN.

20. The wireless device of claim 19, wherein said scan request is in the form of a probe request in accordance with said IEEE 802.11 standards, wherein said communicating comprises:
sending a probe response as a response to said probe request, wherein said probe response contains a field indicating that said wireless device is operating only as a wireless station, and not as an AP;
receiving a join request in the form of a negotiation frame indicating that said new node is accepting said wireless device as said AP for joining said WLAN;
sending a negotiation response to said new node confirming acceptance to operate as said AP to join said new node as a wireless station; and
receiving a confirmation frame from said new node accepting said wireless device as said AP,
wherein said wireless device starts operating as said AP after receiving said confirmation frame.
